(19) United States
(12) Patent Application Publication
(10) Pub. No.: US 2026/0085709 A1
(43) Pub. Date: Mar. 26, 2026

(54) VEHICLE COMPONENT AND METHOD OF MANUFACTURING VEHICLE COMPONENT

(71) Applicant: FUTABA INDUSTRIAL CO., LTD., Okazaki-shi (JP)

(72) Inventor: Fuyuki Itoh, Okazaki-shi (JP)

(21) Appl. No.: 19/316,671

(22) Filed: Sep. 2, 2025

(30) Foreign Application Priority Data
Sep. 20, 2024 (JP) 2024-163916

(51) Int. Cl. F16B 5/08; F01N 13/18

(52) U.S. Cl. CPC F16B 5/08; F01N 13/1805; F01N 13/1844

(57) ABSTRACT

A vehicle component includes a flow path member provided with a through hole, and a base. The base is welded to an outer peripheral surface of the flow path member so as to cover a mounting region surrounding the through hole. The base includes a contact surface in contact with the mounting region, a communication passage, an attachment portion, a positioning surface formed on a side opposite the contact surface, and an engagement receiving portion. The communication passage extends from a first opening provided in the contact surface to a second opening open to an exterior of the flow path. The attachment portion is provided close to the second opening in the communication passage, and configured to attach a measurement component. The engagement receiving portion is provided on the positioning surface, and configured to be engaged with a positioning jig when the base is welded to the flow path member.

### CROSS-REFERENCE TO RELATED APPLICATIONS

This application claims the benefit of priority based on Japanese Patent Application No. 2024-163916 filed on September 20, 2024 with the Japan Patent Office, of which the entire disclosure is hereby incorporated by reference herein.

### BACKGROUND

The present disclosure relates to a vehicle component and a method of manufacturing the vehicle component.

A sensor boss provided near a through hole in the outer peripheral surface of an exhaust system component of a vehicle is known. The sensor boss includes a communication passage connected to the through hole of the exhaust system component, and a sensor is attached to the communication passage so as to reach an exhaust gas flow path inside the exhaust system component. As an example, a cylindrical sensor boss is disclosed in Japanese Unexamined Patent Application Publication No. 2024-67349. The end face of the sensor boss is inclined relative to its axis, and the entire periphery of the end face is welded to the outer peripheral surface of the exhaust system component.

### SUMMARY

When the sensor boss is welded to the exhaust system component, it is necessary to inhibit spatter from entering the communication passage. In addition, to improve the measurement accuracy of the sensor attached to the sensor boss, it is necessary to precisely determine the position of the sensor boss. Therefore, when the sensor boss of Japanese Unexamined Patent Application Publication No. 2024-67349 is welded to the exhaust system component, it is considered to block an opening of the communication passage of the sensor boss using a boss plug and press the boss plug using a fixing jig, thereby fixing the position of the sensor boss.

However, the sensor boss of Japanese Unexamined Patent Application Publication No. 2024-67349 is inclined relative to the exhaust system component. Thus, the fixing jig may interfere with a welding torch during welding, potentially resulting in cases where the welding cannot be performed or where the welding quality is degraded due to an improper posture of the welding torch.

In one aspect of the present disclosure, it is desirable to perform welding properly.

One embodiment of this disclosure is a vehicle component including a flow path member, a through hole, and a base. The flow path member forms a flow path of a fluid. The through hole is a hole passing through the flow path member. The base is welded to an outer peripheral surface of the flow path member so as to cover a mounting region that is a region surrounding the through hole in the outer peripheral surface. The base includes a contact surface, a communication passage, an attachment portion, a positioning surface, and an engagement receiving portion. The contact surface is in contact with the mounting region. The communication passage is a hole extending to pass through the base from a first opening to a second opening, the first opening being provided in the contact surface so as to be connected to the through hole, the second opening being open to an exterior of the flow path. The attachment portion is provided on an inner peripheral surface surrounding the communication passage, close to the second opening, and configured to attach a measurement component for use in measurement related to the fluid passing through the flow path. The positioning surface is formed on a side opposite the contact surface. The engagement receiving portion is provided on the positioning surface and configured to be engaged with a positioning jig that is used to fix a position of the base when the base is welded to the outer peripheral surface of the flow path member.

In the above configuration, when the base is welded to the mounting region of the flow path member, the position of the base can be fixed using the positioning jig that is arranged, with respect to the base, on a side opposite the contact surface in contact with the flow path member, thereby ensuring a space on a lateral side of the base for welding. Thus, it is possible to properly perform welding.

In one embodiment of this disclosure, the engagement receiving portion may include at least one recess.

In the above configuration, the positioning jig can be suitably engaged with the engagement receiving portion.

In one aspect of the present disclosure, the at least one recess of the engagement receiving portion may be a circular hole.

In the above configuration, it is easier to engage the positioning jig with the engagement receiving portion.

In one aspect of the present disclosure, the engagement receiving portion may include at least one protrusion.

In the above configuration, the positioning jig can be suitably engaged with the engagement receiving portion.

In one aspect of the present disclosure, the at least one protrusion of the engagement receiving portion may be a cylindrical protrusion.

In the above configuration, it is easier to engage the positioning jig with the engagement receiving portion.

In one aspect of the present disclosure, the base may further include an attachment surface that includes the second opening formed therein and that is different from the positioning surface. In the communication passage, a section provided with the attachment portion may extend from the second opening along an axis. The axis may extend in a direction that is not parallel to a reference line substantially perpendicular to the through hole.

In the above configuration, the measurement component can be suitably attached to the base.

In one aspect of the present disclosure, the base may further include a side surface and a held portion. The side surface extends from a periphery of the positioning surface toward the contact surface. The held portion is a portion that is provided on the side surface and that comes into contact with the positioning jig when the base is welded to the outer peripheral surface of the flow path member.

In the above configuration, when the position of the base is fixed by a positioning jig to weld the base to the outer peripheral surface of the flow path member, the positioning jig is less likely to shift its position relative to the base.

In one aspect of the present disclosure, the held portion includes two regions extending in a substantially flat shape on the side surface, the two regions being located on opposite sides with the positioning surface interposed therebetween.

In the above configuration, it is possible to inhibit the positioning jig from shifting its position relative to the base.

In one aspect of the present disclosure, the fluid may be an exhaust gas. The vehicle component may be configured as an exhaust gas purification device.

In the above configuration, it is possible to reduce cases where the welding of the base to the exhaust gas purification device is hindered.

In one aspect of the present disclosure, a method of manufacturing the vehicle component may include; placing the base on the outer peripheral surface of the flow path member so that the first opening is connected to the through hole and the contact surface is in contact with the mounting region; fixing the position of the base by the positioning jig engaged with the engagement receiving portion of the positioning surface of the base; closing the second opening of the base with a lid member; and welding the base to the outer peripheral surface of the flow path member.

The above configuration secures a space for arranging equipment for carrying out welding on a lateral side of the base, thereby allowing for proper welding of the base. It is also possible to inhibit spatter generated during welding from entering the second opening of the base.

### BRIEF DESCRIPTION OF THE DRAWINGS

Example embodiments of the present disclosure will be described with reference to the drawings.

FIG. 1A is a perspective view of a base of the first embodiment. FIG. 1B is a side view of the base of the first embodiment.

FIG. 2A is a front view of the base of the first embodiment. FIG. 2B is a top view of the base of the first embodiment. FIG. 2C is an explanatory diagram of a placement step.

FIG. 3A is a perspective view of the base, a flow path member, a positioning jig, and a welding torch in a welding step of the first embodiment. FIG. 3B is a cross-sectional view of the base, the flow path member, the positioning jig, and the welding torch in the welding step of the first embodiment, including an axis and a reference line.

FIG. 4A is a perspective view of a base of a second embodiment. FIG. 4B is a side view of the base of the second embodiment. FIG. 4C is a front view of the base of the second embodiment. FIG. 4D is a top view of the base of the second embodiment.

FIG. 5A is a perspective view of a base of a third embodiment. FIG. 5B is a side view of the base of the third embodiment. FIG. 5C is a front view of the base of the third embodiment. FIG. 5D is a top view of the base of the third embodiment.

FIG. 6A is a perspective view of a base of a fourth embodiment. FIG. 6B is a side view of the base of the fourth embodiment. FIG. 6C is a front view of the base of the fourth embodiment. FIG. 6D is a top view of the base of the fourth embodiment.

FIG. 7A is a perspective view of a base of a fifth embodiment. FIG. 7B is a side view of the base of the fifth embodiment. FIG. 7C is a front view of the base of the fifth embodiment. FIG. 7D is a top view of the base of the fifth embodiment.

FIG. 8A is a perspective view of a base of a sixth embodiment. FIG. 8B is a cross-sectional view of the base of the sixth embodiment, including an axis. FIG. 8C is a front view of the base of the sixth embodiment. FIG. 8D is a top view of the base of the sixth embodiment.

### DETAILED DESCRIPTION OF EXEMPLARY EMBODIMENTS

### 1. FIRST EMBODIMENT

### 1. OVERVIEW

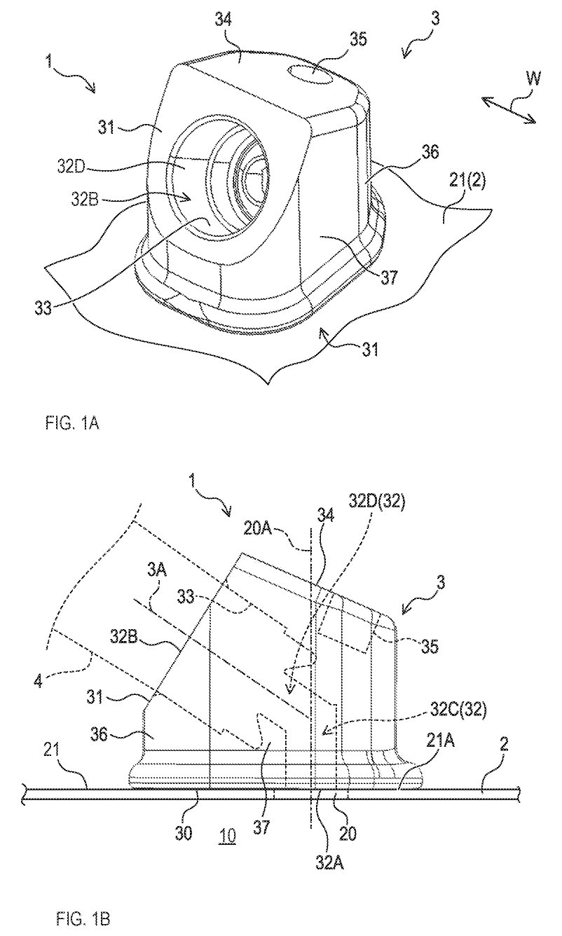

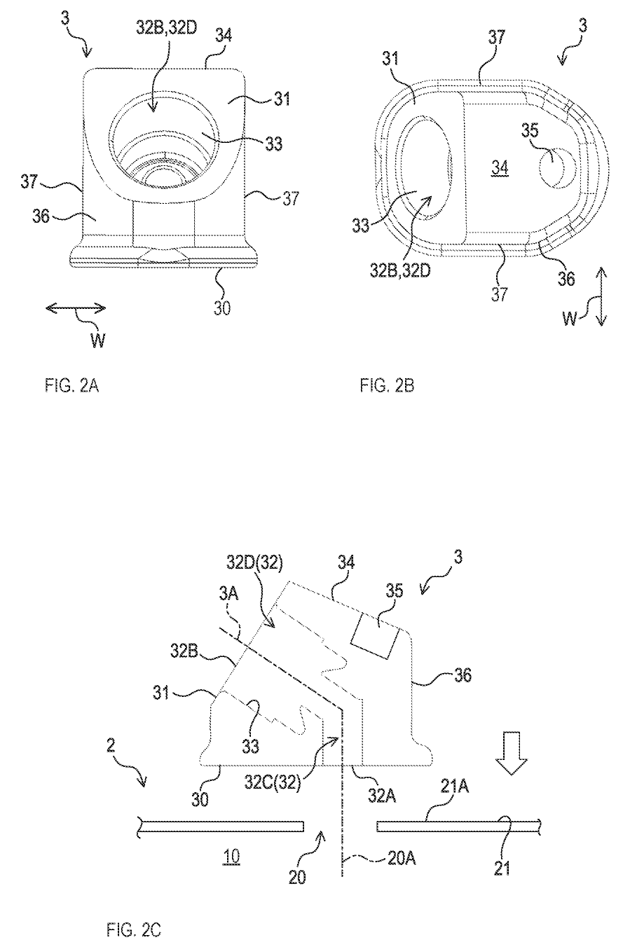

A vehicle component of a first embodiment serves as an exhaust system component forming a flow path of an exhaust gas from an engine of a vehicle. Specifically, the vehicle component serves as an exhaust gas purification device 1 configured to purify the exhaust gas (see FIGS. 1A to 2B). More specifically, the exhaust gas purification device 1 may be a catalytic converter. The vehicle component may also be an exhaust pipe, an exhaust manifold, and a muffler. Of course, the vehicle component is not limited to the foregoing, and may be a component forming a flow path of fluids other than the exhaust gas.

The exhaust gas purification device 1 includes a flow path member 2 that is a plate-shaped member forming a flow path 10 of an exhaust gas, a base 3 for attaching a measurement component 4, which is used in measurement related to the exhaust gas flowing the flow path 10, to the exhaust gas purification device 1. The measurement component 4 may be a sensor for measuring, for example, the temperature or oxygen concentration of the exhaust gas, or a differential pressure piping. The differential pressure piping is a member forming a flow path that branches from the exhaust gas flow path 10. At the tip of the differential pressure piping, a sensor for measuring the pressure of the exhaust gas in the flow path 10 is provided.

### 2. FLOW PATH MEMBER

The flow path member 2 includes a through hole 20 that passes through the flow path member 2 and connects the exhaust gas flow path 10 to the external space (see FIG. 1B). The through hole 20 is formed, for example, in the flow path member 2 in a portion extending in a substantially flat shape, and has a substantially circular shape. Hereinafter, a virtual straight line that is substantially perpendicular to the through hole 20 (more specifically, an opening defined by the through hole 20) and passes through a center of the through hole 20 is referred to as a reference line 20A.

### 3. BASE

The base 3 is a member for attaching the measurement component 4 to the through hole 20 of the flow path member 2 and has a sensor boss configuration (see FIGS. 1A to 2B). The base 3 is welded to an outer peripheral surface 21 of the flow path member 2 so as to cover a mounting region 21A surrounding the through hole 20 on the outer peripheral surface 21. The mounting region 21A extends, for example, in a substantially flat shape. The base 3 includes a contact surface 30, an attachment surface 31, a communication passage 32, an attachment portion 33, a positioning surface 34, an engagement receiving portion 35, a side surface 36, and a held portion 37.

### <Contact Surface>

The contact surface 30 is a portion of the outer surface of the base 3, extending in a substantially flat shape and is in contact with the mounting region 21A of the flow path member 2 (see FIGS. 1A to 2B). The periphery of the contact surface 30 is welded to the mounting region 21A over its entire periphery. Additionally, the contact surface 30 includes a first opening 32A formed therein.

### <Attachment Surface>

The attachment surface 31 is a portion of the outer surface of the base 3, which extends in a substantially flat shape and to which the measurement component 4 is provided (see FIGS. 1A to 2B). The attachment surface 31 is a surface that is different from the positioning surface 34 and that is inclined toward the reference line 20A of the through hole 20 so as to be closer to the reference line 20A with increasing distance from the flow path member 2. Additionally, the attachment surface 31 includes a second opening 32B.

### <Communication Passage>

The communication passage 32 is a hole that passes through the base 3, extends from the first opening 32A to the second opening 32B, and includes first and second sections 32C and 32D (see FIGS. 1A to 2B). Furthermore, the communication passage 32 connects the exhaust gas flow path 10 in the flow path member 2 with the exterior of the flow path member 2.

The first opening 32A is arranged to communicate with the through hole 20 of the flow path member 2, and the first section 32C extends from the first opening 32A along the reference line 20A.

The second section 32D extends along an axis 3A from the second opening 32B, which is open to the exterior of the exhaust gas flow path 10, and is connected to the end of the first section 32C. Note that the axis 3A is a virtual straight line that is substantially perpendicular to the second opening 32B (i.e., the attachment surface 31) and that is not parallel to the reference line 20A. In other words, the second section 32D is inclined relative to the direction of the reference line 20A of the through hole 20 of the flow path member 2. Note that the first section 32C and the second section 32D may be connected to each other so as to extend in a straight line.

### <Attachment Portion>

The attachment portion 33 for attaching the measurement component 4 is provided in a portion close to the second opening 32B on an inner peripheral surface surrounding the second section 32D of the communication passage 32 (see FIGS. 1A to 2B). The attachment portion 33 may be, for example, in the form of a female screw for securing the measurement component 4. The attachment portion 33 is provided adjacent to the second opening 32B and surrounds a cylindrical space extending along the axis 3A. Furthermore, in the second section 32D, a diameter of a portion where the attachment portion 33 is located is enlarged. In the attachment portion 33, a step is formed at an end opposite the second opening 32B.

### <Positioning Surface>

The positioning surface 34 is a portion on the outer surface of the base 3, extending in a substantially flat shape and located on a side opposite the contact surface 30 (see FIGS. 1A to 2B). More specifically, the positioning surface 34 is, for example, adjacent to the attachment surface 31 and located on a side opposite the first opening 32A. That is, the positioning surface 34 is located in a position substantially facing the first opening 32A. Additionally, the positioning surface 34 is inclined relative to the contact surface 30 so as to be closer to the flow path member 2 with increasing distance from the attachment surface 31.

### <Engagement Receiving Portion>

The engagement receiving portion 35 is provided on the positioning surface 34 (see FIGS. 1A and 2B). The engagement receiving portion 35 is configured to be engaged with a positioning jig 5 that fixes the position of the base 3 when the base 3 is welded to the mounting region 21A of the flow path member 2 at the time of manufacturing the exhaust gas purification device 1 (details are described below).

The engagement receiving portion 35 is, as an example, formed as a circular hole (or, in other words, a recess) in the positioning surface 34. This makes it easier to manufacture the base 3 compared to a case where the engagement receiving portion 35 is a rectangular hole. Furthermore, when the engagement receiving portion 35 is circular, it is easier to fit the engagement portion 53 of the positioning jig 5 described below compared to a case where the engagement receiving portion 35 is a rectangular hole. The engagement receiving portion 35 is, for example, located substantially at the center in a width direction W of the positioning surface 34 and located close to an end of the positioning surface 34 opposite the attachment surface 31. Note that the width direction W refers to a direction perpendicular to the axis 3A.

### <Side Surface>

The side surface 36 is a portion of the outer surface of the base 3, laterally located and extending from a periphery of a combined section of the attachment surface 31 and the positioning surface 34 to the contact surface 30 (see FIGS. 1A to 2B). The side surface 36 extends so as to surround the base 3.

### <Held Portion>

The held portion 37 is provided on the side surface 36 of the base 3 (see FIGS. 1A to 2B) and comes into contact with the positioning jig 5 when the base 3 is welded to the mounting region 21A of the flow path member 2 at the time of manufacturing the exhaust gas purification device 1 (details are described below). In this embodiment, as an example, the held portion 37 is formed as two regions extending in a substantially flat shape on the side surface 36. These regions are located on opposite sides with the combined section of the attachment surface 31 and the positioning surface 34 interposed therebetween.

### 4 WELDING PROCESS OF THE BASE

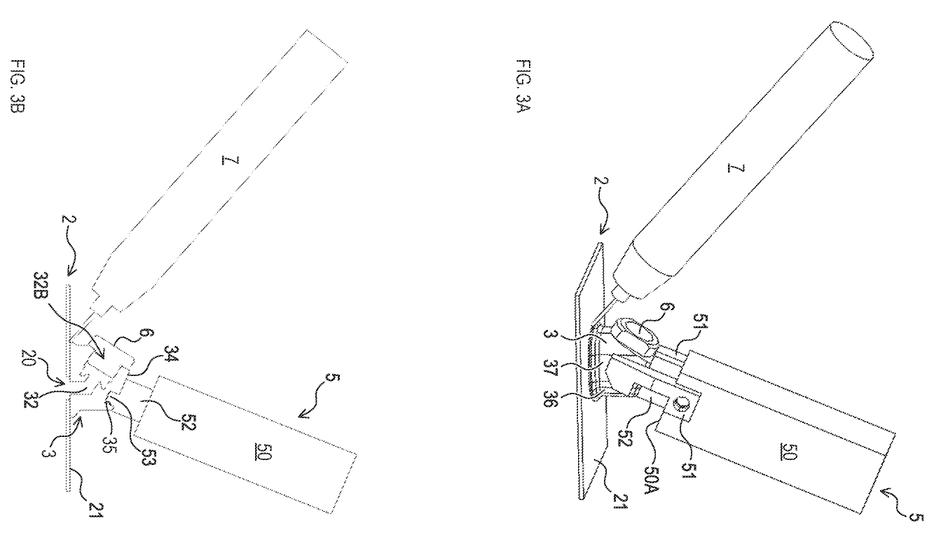

The method of manufacturing the exhaust gas purification device 1 includes a welding process in which the base 3 is welded to the flow path member 2 (see FIGS. 2C to 3B). The welding process includes a placement step, a fixing step, a closing step, and a welding step.

### <Placement Step>

In the placement step, the base 3 is placed on the mounting region 21A of the outer peripheral surface 21 of the flow path member 2 (see FIG. 2C). At this time, the first opening 32A of the contact surface 30 of the base 3 is connected to the through hole 20, and the contact surface 30 is in contact with the mounting region 21A. As a result, the entire through hole 20 is covered by the base 3, and the exhaust gas flow path 10 of the flow path member 2 and the external space of the flow path member 2 communicate with each other via the communication passage 32 of the base 3.

### <Fixing Step>

In the fixing step following the placement step, the position of the base 3, which is placed on the mounting region 21A, relative to the flow path member 2 is fixed using the positioning jig 5 (see FIGS. 3A and 3B).

### <Positioning Jig>

The positioning jig 5 includes a main body 50, two arms 51, a positioning portion 52, and an engagement portion 53 (see FIGS. 3A and 3B).

The main body 50 is a rod-shaped portion and, in this embodiment, is formed as a square column in one example.

The two arms 51 are provided on an outer peripheral surface of the main body 50, are located close to an end face 50A, and protrude from the end face 50A. The two arms 51 face each other with the end face 50A and the positioning portion 52 interposed therebetween.

The positioning portion 52 is a cylindrical portion protruding from the end face 50A of the main body 50.

The engagement portion 53 is a protrusion provided on a tip end face of the positioning portion 52.

### <Details of Fixing Step>

In the fixing step, the engagement portion 53 of the positioning portion 52 of the positioning jig 5 is engaged with the engagement receiving portion 35 of the positioning surface 34 of the base 3 (see FIGS. 3A and 3B). Specifically, the engagement is achieved by the engagement portion 53 of the positioning jig 5, which is a protrusion, fitting into the engagement receiving portion 35 of the base 3, which is a circular hole. Note that the engagement portion 53 may fit into the engagement receiving portion 35 without any gaps or with a slight clearance. Alternatively, the engagement may be achieved by the engagement portion 53 being hooked on the engagement receiving portion 35.

At this time, the two arms 51 of the positioning jig 5 are in contact with the held portion 37 on the side surface 36 of the base 3. This inhibits the positioning jig 5, with the engagement portion 53 being engaged with the engagement receiving portion 35, from rotating around the engagement receiving portion 35. Specifically, the two arms 51 are respectively in contact with the regions forming the held portion 37 on the side surface 36 of the base 3, whereby the two arms 51 laterally clamp the base 3.

Then, the base 3 is pressed against the flow path member 2 using the positioning jig 5, in which the engagement portion 53 is engaged with the engagement receiving portion 35 and the two arms 51 are in contact with the two regions of the held portion 37. The position of the base 3 is thereby fixed relative to the flow path member 2.

### <Closing Step>

In the closing step, the second opening 32B of the base 3 is closed by the lid member 6 (see FIGS. 3A and 3B). The lid member 6 is arranged to cover the entire area of the second opening 32B and, as an example, to cover substantially the entire area of the attachment surface 31.

### <Welding Step>

In the welding step, the base 3, which is placed on the mounting region 21A of the flow path member 2, is welded (see FIGS. 3A and 3B). At this time, the second opening 32B of the base 3 is closed by the lid member 6 through the closing step, and the position of the base 3 relative to the flow path member 2 is fixed by the positioning jig 5 through the fixing step. In the welding step, a welding torch 7 is moved around the base 3 to weld the entire periphery of the contact surface 30 of the base 3 to the mounting region 21A.

### 2. SECOND EMBODIMENT

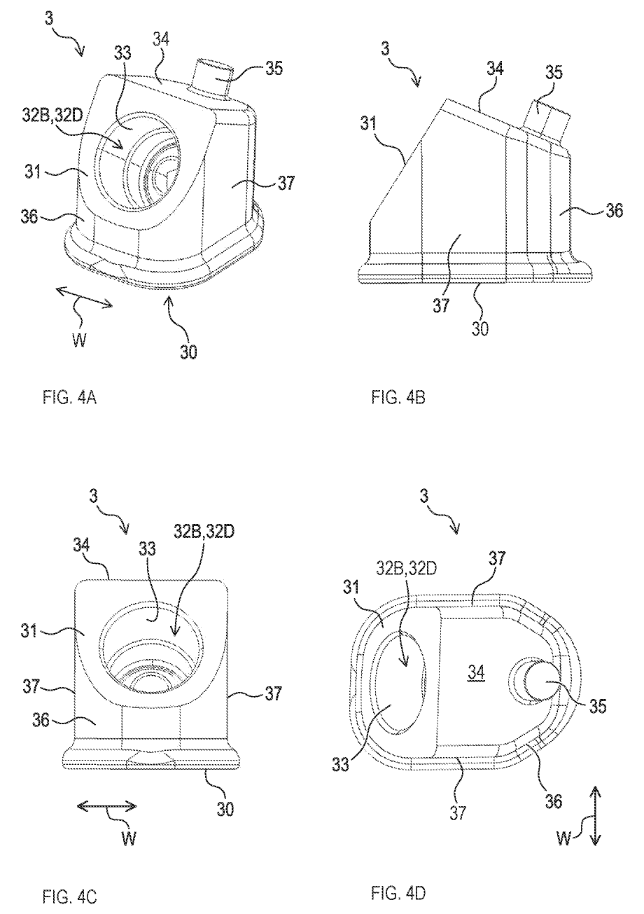

The second embodiment differs from the first embodiment in the configuration of the engagement receiving portion 35 of the base 3 and the configuration of the engagement portion 53 of the positioning jig 5 (see FIGS. 4A to 4D). Hereinafter, differences between the second embodiment and the first embodiment are described.

In the second embodiment, the engagement receiving portion 35 of the base 3 has a cylindrical portion protruding from the positioning surface 34. The engagement portion 53 of the positioning jig 5 has a circular hole defining a cylindrical space similar to the engagement receiving portion 35.

In the fixing step, the engagement receiving portion 35 of the base 3 is engaged with the engagement portion 53 of the positioning jig 5 in the same manner as in the first embodiment, such that the engagement receiving portion 35 is engaged with or hooked on the engagement portion 53.

Note that the engagement receiving portion 35 may have a plurality of protrusions provided on the positioning surface 34. In this case, each protrusion may have a cylindrical shape or a shape different from the cylindrical shape. Furthermore, the engagement portion 53 may have a plurality of holes corresponding to these protrusions. The engagement receiving portions 35 and the engagement portions 53 may be engaged with each other in the same manner.

### 3. THIRD EMBODIMENT

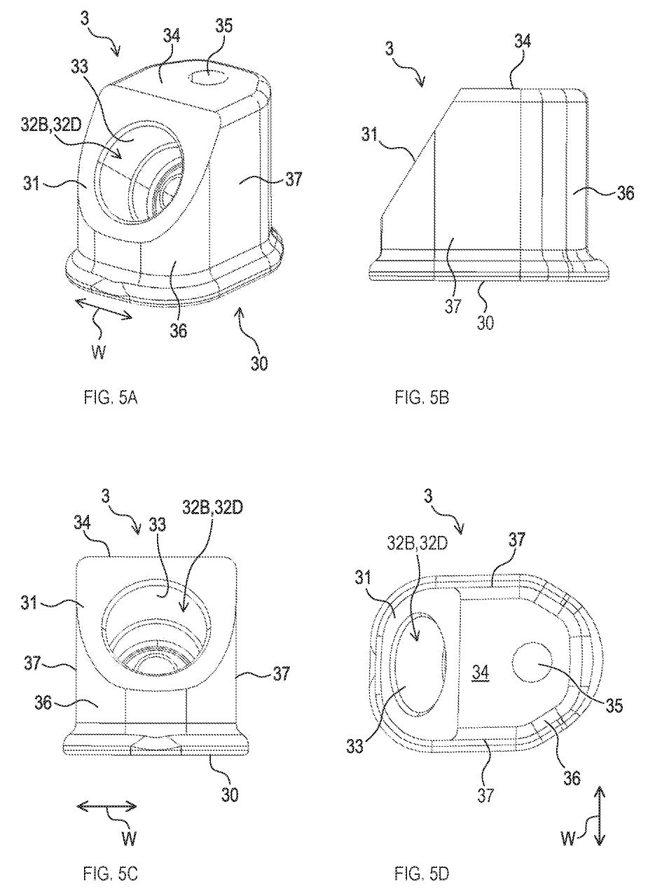

The third embodiment differs from the first embodiment in the orientation of the positioning surface 34 of the base 3 (see FIGS. 5A to 5D). Specifically, in the third embodiment, the positioning surface 34 is substantially parallel to the contact surface 30.

### 4. FOURTH EMBODIMENT

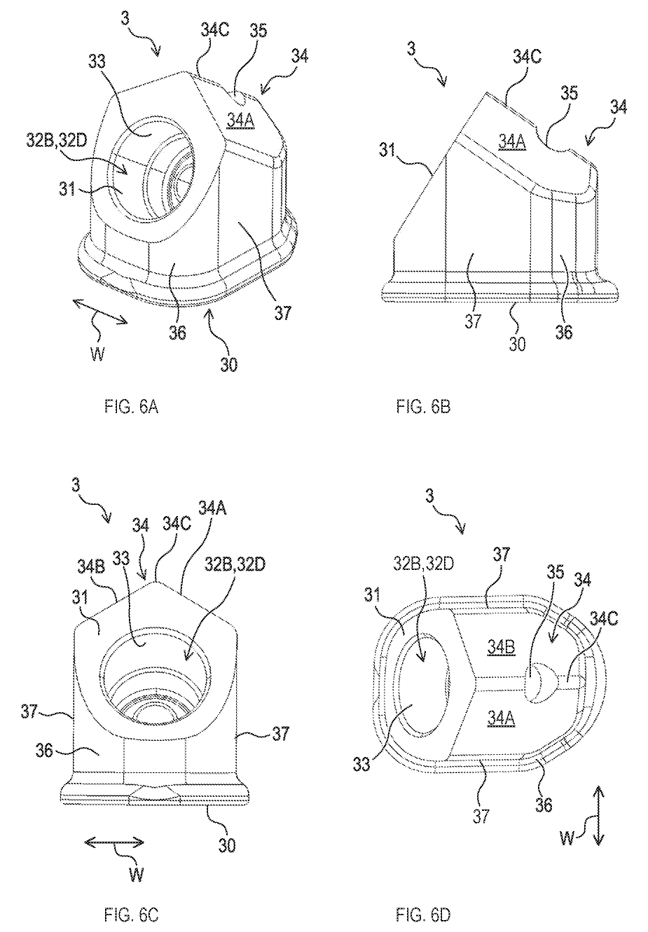

The fourth embodiment differs from the first embodiment in the configuration of the positioning surface 34 of the base 3 (see FIGS. 6A to 6D). Specifically, in the fourth embodiment, the positioning surface 34 includes first and second regions 34A and 34B that extend in a substantially flat shape. The first and second regions 34A and 34B are located on a first-end side and a second-end side in the width direction W, respectively. In the approximate center of the width direction W of the positioning surface 34, a boundary line 34C between the first and second regions 34A and 34B extends in a substantially straight line. The first and second regions 34A and 34B are inclined, as they extend toward the boundary line 34C, so as to protrude in a direction opposite the contact surface 30. An engagement receiving portion 35 similar to that of the first embodiment is formed on the boundary line 34C.

### 5. FIFTH EMBODIMENT

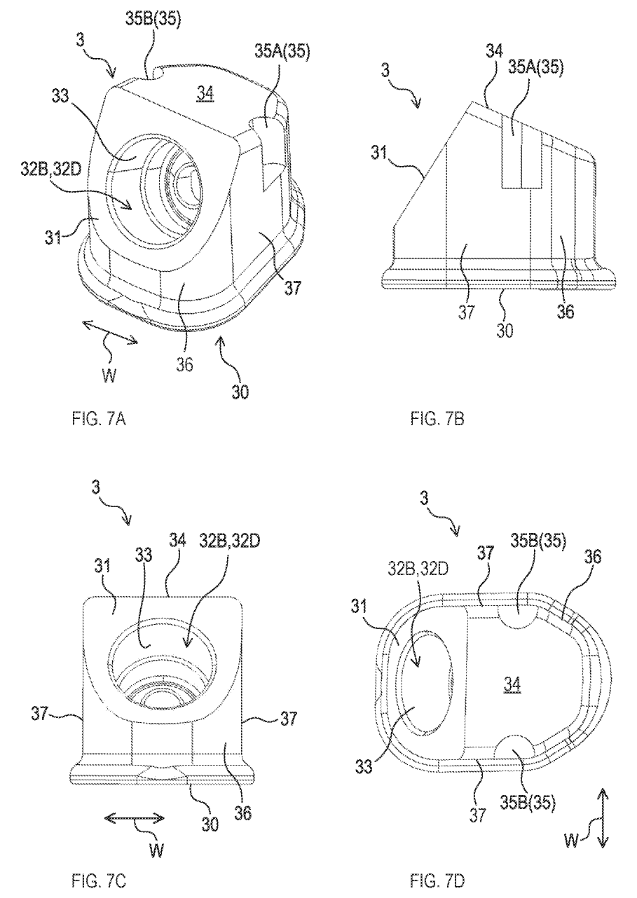

The fifth embodiment differs from the first embodiment in the configuration of the engagement receiving portion 35 of the base 3 (see FIGS. 7A to 7D).

In the fifth embodiment, the engagement receiving portion 35 includes first and second portions 35A and 35B. The first and second portions 35A and 35B are located at both ends of the positioning surface 34 in the width direction W and are formed as elongated cutouts (or, in other words, recesses) extending in the direction of the reference line 20A from the positioning surface 34.

In other words, each of the first and second portions 35A and 35B is a groove-shaped portion formed on the side surface 36 of the base 3, extending in the direction of the reference line 20A from the positioning surface 34, and having an open end on a side close to the positioning surface 34 and a closed end with a bottom surface on the opposite side. Note that the cross-section perpendicular to the extension direction of the first and second portions 35A and 35B is, for example, substantially semicircular; however, this shape is not limited thereto and may be determined as appropriate.

The engagement portion 53 of the positioning jig 5 includes two rod-shaped portions that are configured to be engaged with the first and second portions 35A and 35B of the engagement receiving portion 35 of the base 3.

In the fixing step, the two rod-shaped portions of the engagement portion 53 of the positioning jig 5 enter the first and second portions 35A and 35B of the engagement receiving portion 35 of the base 3, respectively, whereby the engagement receiving portion 35 is engaged with the engagement portion 53.

### 6. SIXTH EMBODIMENT

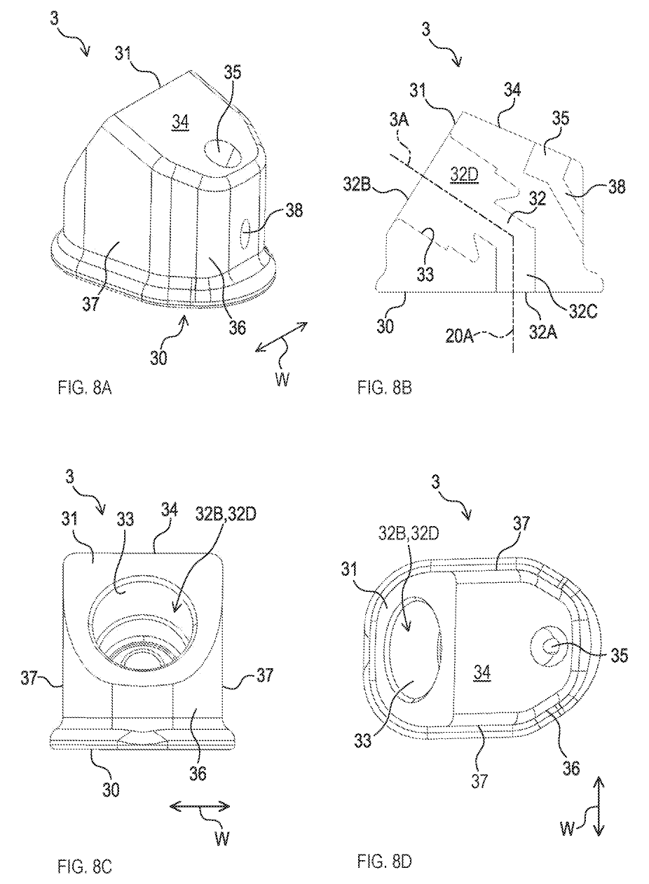

The sixth embodiment differs from the first embodiment in that a drain flow path 38 is provided in the base 3 (see FIGS. 8A to 8D). The drain flow path 38 is a hole that passes through the base 3 and extends in a substantially straight line from a bottom portion of the engagement receiving portion 35 to a position on a side opposite the attachment surface 31 on the side surface 36 of the base 3.

### 7. EFFECTS

(1) In the above embodiments, during the fixing step of the welding process of the base 3, the position of the base 3 can be fixed by the positioning jig 5 placed on a side opposite the contact surface 30 of the base 3. This ensures a space for arranging the welding torch 7 on the lateral side of the base 3. Thus, the positioning jig 5 less interferes with the welding torch 7 during welding, thereby reducing cases where welding cannot be performed or where the welding quality is degraded due to an improper posture of the welding torch 7. Thus, welding can be performed properly.

(2) The positioning surface 34 of the base 3 is formed as a surface different from the attachment surface 31 where the second opening 32B is provided. During the closing step of the welding process of the base 3, the second opening 32B is closed by the lid member 6. This inhibits spatter generated during welding from entering the second opening 32B of the base 3.

(3) The second section 32D of the communication passage 32 of the base 3, where the attachment portion 33 for the measurement component 4 is provided, (i.e., the axis 3A) is inclined relative to the reference line 20A that is substantially perpendicular to the through hole 20 of the flow path member 2. This allows the measurement component 4 to be appropriately attached to the base 3.

(4) The side surface 36 of the base 3 is provided with the held portion 37. During the fixing step of the welding process of the base 3, the two arms 51 of the positioning jig 5 come into contact with the two regions of the held portion 37, thereby fixing the base 3. Thus, as in the first to fourth and sixth embodiments, even if the engagement receiving portion 35 of the base 3 is a circular hole or a cylindrical protrusion and the positioning jig 5 engaged with the engagement receiving portion 35 may rotate around the engagement receiving portion 35, the position of the positioning jig 5 is less likely to shift relative to the base 3.

### 8. OTHER EMBODIMENTS

(1) The base 3 of the above embodiments is formed such that the positioning surface 34 is a surface different from the attachment surface 31 for the measurement component 4. However, the configuration is not limited thereto, and the positioning surface 34 and the attachment surface 31 may be the same surface. That is, a surface around the second opening 32B of the communication passage 32 may be formed as a positioning surface, and the positioning surface may be provided with the engagement receiving portion.

(2) In the base 3 of the above embodiments, the two regions on the side surface 36 each extending in a substantially flat shape are formed as the held portion 37 to be in contact with the two arms 51 of the positioning jig 5 during the fixing step of the welding process. However, the held portion is not limited to this configuration, and two regions having curved or uneven surfaces on the side surface 36 may also be used as the held portion. Alternatively, two regions having engagement portions (e.g., holes or protrusions) on the side surface 36 may be used as the held portion, and the two arms 51 of the positioning jig 5 may be engaged with the engagement portions of these regions, respectively.

In addition, for example, N regions (where N is a positive integer equal to or greater than 3) on the side surface 36 may be formed as the held portion 37, and during the fixing step of the welding process, N arms 51 of the positioning jig 5 may contact these regions. Alternatively, for example, a single wide area on the side surface 36 may be defined as the held portion 37, and during the fixing step of the welding process, one arm 51 of the positioning jig 5 may contact the area to thereby inhibit the positioning jig 5 from rotating around the engagement receiving portion 35.

(3) The positioning jig 5 used in the fixing step of the welding process of the base 3 in the fifth embodiment does not necessarily include the two arms 51. Even in such a case, since the engagement receiving portion 35 of the base 3 in the fifth embodiment includes the first and second portions 35A and 35B, the positioning jig 5 engaged with the engagement receiving portion 35 is less likely to rotate around the engagement receiving portion 35. Thus, it is possible to inhibit the position of the positioning jig 5 from shifting relative to the base 3.

Furthermore, in the first to fourth and sixth embodiments, the engagement receiving portion 35 of the base 3 may have a shape that can inhibit the positioning jig 5 engaged with the engagement receiving portion 35 from rotating around the engagement receiving portion 35. Specifically, in the first, third, fourth, and sixth embodiments, the engagement receiving portion 35 may be, for example, an elongated (e.g., oval) hole or a polygonal (e.g., rectangular) hole. In the second embodiment, the engagement receiving portion 35 may be, for example, a rectangular columnar protrusion. In addition, the positioning jig 5 used in the fixing step of the welding process does not necessarily include the two arms 51. Even in such a case, it is possible to inhibit the position of the positioning jig 5 from shifting relative to the base 3.

(4) The shape of the base 3 is not limited to those described in the first to sixth embodiments and may be appropriately determined. Specifically, for example, the base 3 may have an elongated shape.

(5) Two or more functions of one element of the aforementioned embodiments may be achieved by two or more elements, and one function of one element may be achieved by two or more elements. Furthermore, two or more functions of two or more elements may be achieved by one element, and one function achieved by two or more elements may be achieved by one element. A part of the configurations of the aforementioned embodiments may be omitted. Furthermore, at least part of the configurations of the aforementioned embodiments may be added to or replaced with another configuration of the aforementioned embodiments.

### 9. TECHNICAL IDEAS DISCLOSED HEREIN

[Item 1]

A vehicle component including:

a flow path member forming a flow path of a fluid;

a through hole that is a hole passing through the flow path member; and

a base welded to an outer peripheral surface of the flow path member so as to cover a mounting region that is a region surrounding the through hole in the outer peripheral surface;

the base including

a contact surface in contact with the mounting region,

a communication passage that is a hole extending to pass through the base from a first opening to a second opening, the first opening being provided in the contact surface so as to be connected to the through hole, the second opening being open to an exterior of the flow path,

an attachment portion that is provided on an inner peripheral surface surrounding the communication passage, that is located close to the second opening, and that is configured to attach a measurement component for use in measurement related to the fluid passing through the flow path,

a positioning surface formed on a side opposite the contact surface, and

an engagement receiving portion that is provided on the positioning surface and that is configured to be engaged with a positioning jig that is used to fix a position of the base when the base is welded to the outer peripheral surface of the flow path member.

[Item 2]

The vehicle component according to item 1, wherein

the base further includes an attachment surface that includes the second opening formed therein and that is different from the positioning surface,

in the communication passage, a section provided with the attachment portion extends from the second opening along an axis, and

the axis extends in a direction that is not parallel to a reference line substantially perpendicular to the through hole.

[Item 3]

The vehicle component according to item 1 or item 2, wherein

the base further includes

a side surface extending from a periphery of the positioning surface toward the contact surface, and

a held portion that is provided on the side surface and that comes into contact with the positioning jig when the base is welded to the outer peripheral surface of the flow path member.

[Item 4]

The vehicle component according to any one of items 1 to 3, wherein

the fluid is an exhaust gas, and

the vehicle component is configured as an exhaust gas purification device.

[Item 5]

A method of manufacturing the vehicle component according to any one of item 2 and item 3 or 4 depending from item 2, the method including:

placing the base on the outer peripheral surface of the flow path member so that the first opening is connected to the through hole and the contact surface is in contact with the mounting region;

fixing the position of the base by the positioning jig engaged with the engagement receiving portion of the positioning surface of the base;

closing the second opening of the base with a lid member; and

welding the base to the outer peripheral surface of the flow path member.

What is claimed is:

1. A vehicle component comprising:
a flow path member forming a flow path of a fluid;
a through hole that is a hole passing through the flow path member; and
a base welded to an outer peripheral surface of the flow path member so as to cover a mounting region that is a region surrounding the through hole in the outer peripheral surface;
the base including
a contact surface in contact with the mounting region,
a communication passage that is a hole extending to pass through the base from a first opening to a second opening, the first opening being provided in the contact surface so as to be connected to the through hole, the second opening being open to an exterior of the flow path,
an attachment portion that is provided on an inner peripheral surface surrounding the communication passage, that is located close to the second opening, and that is configured to attach a measurement component for use in measurement related to the fluid passing through the flow path,
a positioning surface formed on a side opposite the contact surface, and
an engagement receiving portion that is provided on the positioning surface and that is configured to be engaged with a positioning jig that is used to fix a position of the base when the base is welded to the outer peripheral surface of the flow path member.

2. The vehicle component according to claim 1,
wherein the engagement receiving portion includes at least one recess.

3. The vehicle component according to claim 2,
wherein the at least one recess of the engagement receiving portion is a circular hole.

4. The vehicle component according to claim 1,
wherein the engagement receiving portion includes at least one protrusion.

5. The vehicle component according to claim 4,
wherein the at least one protrusion of the engagement receiving portion is a cylindrical protrusion.

6. The vehicle component according to claim 1, wherein:
the base further includes an attachment surface that includes the second opening formed therein and that is different from the positioning surface,
in the communication passage, a section provided with the attachment portion extends from the second opening along an axis, and
the axis extends in a direction that is not parallel to a reference line substantially perpendicular to the through hole.

7. The vehicle component according to claim 1,
wherein the base further includes
a side surface extending from a periphery of the positioning surface toward the contact surface, and
a held portion that is provided on the side surface and that comes into contact with the positioning jig when the base is welded to the outer peripheral surface of the flow path member.

8. The vehicle component according to claim 7, wherein
the held portion includes two regions extending in a substantially flat shape on the side surface, the two regions being located on opposite sides with the positioning surface interposed therebetween.

9. The vehicle component according to claim 1, wherein:
the fluid is an exhaust gas, and
the vehicle component is configured as an exhaust gas purification device.

10. A method of manufacturing the vehicle component according to claim 6, the method comprising:
placing the base on the outer peripheral surface of the flow path member so that the first opening is connected to the through hole and the contact surface is in contact with the mounting region;
fixing the position of the base by the positioning jig engaged with the engagement receiving portion of the positioning surface of the base;
closing the second opening of the base with a lid member; and
welding the base to the outer peripheral surface of the flow path member.
